(19) United States
(12) Patent Application Publication
(10) Pub. No.: US 2008/0215823 A1
(43) Pub. Date: Sep. 4, 2008

(54) DATA CONSISTENCY CONTROL SYSTEM AND DATA CONSISTENCY CONTROL METHOD

(76) Inventor: TAKEO HOSOMI, Tokyo (JP)

Correspondence Address: NEC CORPORATION OF AMERICA, 6535 N. STATE HWY 161, IRVING, TX, 75039, US

(21) Appl. No.: 12/027,671

(22) Filed: Feb. 7, 2008

(30) Foreign Application Priority Data
Feb. 8, 2007 (JP) 2007-029248

(51) Int. Cl. G06F 12/08

(52) U.S. Cl. 711/146; 711/E12.017

(57) ABSTRACT

In a data consistency control system, a plurality of cache agents and at least one home agent are connected to one another by a plurality of networks. The home agent includes a unit issuing a snoop request when receiving an access request. Each of the cache agents includes a unit issuing a snoop response to the home agent when receiving the snoop request, and a unit issuing a snoop retry response. Each of the cache agents also includes a unit causing the snoop response and the snoop retry response to be communicated via different networks. The home agent also includes a unit managing the snoop retry response and a unit reissuing the snoop request by the management unit.

### REFERENCE TO RELATED APPLICATION

This application is based upon and claims the benefit of priority from Japanese patent application No. 2007-029248, filed on Feb. 8, 2007, the disclosure of which is incorporated herein in its entirety by reference.

### BACKGROUND OF THE INVENTION

1. Field of the Invention

The present invention relates to a data consistency control system and a data consistency control method. More specifically, the present invention relates to a data consistency control system and a data consistency control method for exerting a control over data consistency with small HW (hardware) amount without causing deadlock.

2. Description of the Related Art

Conventionally, there is known a data consistency control system for controlling data consistency without causing deadlock as disclosed in Japanese Patent Number 3751741 (Japanese Patent Application Laid-Open No. 11-219343), entitled “multiprocessor system”.

FIG. 12 shows an example of a configuration of the data consistency control system disclosed-in the Japanese Patent Number 3751741.

As shown in FIG. 12, the data consistency control system disclosed in the Japanese Patent Number 3751741 is configured so that a plurality of cache agents 1021 (1021-1 to 1021-n) and a plurality of home agents 1031 (1031-1 to 1031-n) are connected to one another by a network 1011.

In FIG. 12, n and m are natural numbers and mean allocated numeric values, which shall apply hereafter.

The cache agent 1021-1 includes a cache controller 1055 controlling data consistency in the cache agent 1021-1 as well as a snoop request reception buffer 1051, an access response reception buffer 1052, and an access request-snoop response transmission buffer 1053 that are message transmission or reception buffers.

The home agent 1031-1 includes a home controller 1065 controlling data consistency in the home agent 1031-1 and an access request management table 1064 recording an access request issued by each of the cache agents 1021-1 to 1021-n and managing a processing state as well as an access request-snoop response reception buffer 1061 and a snoop request-access response transmission buffer 1062 that are message transmission or reception buffers.

Access request information 1071 and a response counter 1072 are stored in respective entries managed by the access request management table 1064 (See, FIG. 13).

The cache agent 1021-1 accesses data held by the home agent 1031-1 and holds a copy of the data.

Since a plurality of cache agents 1021 hold copies of the same data, it is necessary to keep data consistency between each of the copies and the data stored in a memory (not shown). A control for keeping the data consistency will be referred to as “data consistency control” hereinafter.

This data consistency control is exerted by communicating messages between the cache agents 1021 and the home agents 1031 via the network 1011.

For example, if the cache agent 1021-1 is to newly access data held by a certain home agent 1031 (e.g., 1031-1), the cache controller 1055 generates an access request message addressed to the home agent 1031-1 and outputs the message to the access request-snoop response transmission buffer 1053.

The access request message stored in the access request-snoop response transmission buffer 1053 is transmitted to the access request-snoop response reception buffer 1061 of the home agent 1031-1 via the network 1011.

The home agent 1031-1 receives the access request message from the access request-snoop response reception buffer 1061, and registers access request information 1071 (FIG. 13) on the received access request in the access request management table 1064.

Furthermore, the home agent 1031-1 generates a plurality of snoop request messages addressed to all the other cache agents 1021-2 to 1021-n, respectively, and outputs the generated snoop request messages to the snoop request-access response transmission buffer 1062. At the same time, the home agent 1031-1 sets the number of generated snoop request messages to the response counter 1072 (FIG. 13) of the access request management table 1064.

It is to be noted that configurations of the cache agents other than the cache agent 1021-1 are similar to that of the cache agent 1021-1 and will not be repeatedly described herein.

The snoop request messages stored in the snoop request-access response transmission buffer 1062 are transmitted to snoop request reception buffers 1051 of the respective cache agents 1021 via the network 1011.

In each cache agent 1021, the cache controller 1055 that has received the snoop request message from the snoop request reception buffer 1051 performs a data consistency processing to generate a snoop response message, and outputs the snoop response message to the access request-snoop response transmission buffer 1053.

The snoop response message stored in the access request-snoop response transmission buffer 1053 is transmitted to the access request-snoop response reception buffer 1061 of the home agent 1031-1 via the network 1011.

The home agent 1031-1 receives the snoop response message from the access request-snoop response reception buffer 1061 and decrements a value of the response counter 1072 (FIG. 13) in the relevant entry of the access request management table 1064.

The home agent 1031-1 receives snoop response messages from a plurality of cache agents 1021. If the home agent 1031-1 receives all the snoop response messages corresponding to the snoop request message issued by the home agent 1031-1, that is, if the value of the response counter 1072 becomes zero as a result of decrementing the response counter 1072, the home agent 1031-1 generates an access response message addressed to the cache agent 1021-1 that has issued the access request message, and outputs the access response message to the snoop request-access response transmission buffer 1062.

The access response message stored in the snoop request-access response transmission buffer 1062 is transmitted to the access response reception buffer 1052 of the addressed cache agent 1021-1 via the network 1011.

The cache agent 1021-1 receives the access response message from the access response reception buffer 1052, thus completing a data access processing.

In this manner, the cache agents 1021 issues a plurality of access requests in parallel, so that a plurality of data consistency controls is exerted in the data consistency control system in parallel.

Due to this, various messages are generated and exchanged from the cache agents 1021 (1021-1 to 1021-n) to the home agents 1031 (1031-1 to 1031-m) via the network 1011.

Moreover, if each of the home agents 1031 (1031-1 to 1031-m) is to perform a processing by receiving the access request message from the access request-snoop response reception buffer 1061, then a blank entry is present in the access request management table 1064, it is necessary that there is a blank entry in the access request management table 1064, and it is also necessary to output the snoop request message to the snoop request-access response transmission buffer 1062.

Furthermore, if each of the home agents 1031 (1031-1 to 1031-m) is to perform a processing by receiving the snoop response message, it is necessary to output the access response message to the snoop request-access response transmission buffer 1062.

Further, each of the cache agents 1021 (1021-1 to 1021-n) is to perform a processing by receiving the snoop request message from the snoop request reception buffer 1051, it is necessary to output the snoop response message to the access request-snoop response transmission buffer 1053.

As can be seen, because of dependence on reception, processing, and transmission of each message, the data consistency control system has a disadvantage of occurrence of deadlock.

The conventional art disclosed in the Japanese Patent Number 3751741 prevents occurrence of deadlock by setting each of the snoop request reception buffer 1051 of the cache agent 1021-1 and the snoop request-access response reception buffer 1062 of the home agent 1031-1 to have a sufficient size so as to prevent the snoop request reception buffer 1051 and the snoop request-access response reception buffer 1062 from overflowing.

This can dispense with providing a plurality of virtual channels in the network.

With this conventional method, however, sizes of the both buffers 1051 and 1062 are disadvantageously made quite large, which may possibly produce various disadvantages.

For example, if the both buffers 1051 and 1062 are realized as circuits in a chip, a hardware amount of the chip increases by the sizes of the buffers 1051 and 1062.

According to the Japanese Patent Number 3751741, an external memory device is connected to the chip and a save region is provided in the external memory device, thereby preventing the hardware amount of the chip from increasing.

However, this method cannot be used if it is difficult to connect an external memory device to the chip.

On the other hand, if a plurality of cache agents 1021 (1021-1 to 1021-n) accesses the same data held by one of the home agents 1031 (1031-1 to 1031-m) almost simultaneously, a contention often occurs.

With the conventional art disclosed in the Japanese Patent Number 3751741, message overflow is prevented in a point-to-point architecture by configuring the network 1011 to include one channel.

By so configuring, a contention state resulting from overtaking of the messages, making it possible to simplify the data consistency control.

Furthermore, an ordinary multiprocessor system other than the multiprocessor system disclosed in the Japanese Patent Number 3751741 is disclosed in Japanese Patent Application Laid-Open No. 2003-150573.

The conventional techniques have the following disadvantages. Although the data consistency control can be simplified, it is necessary to include a sufficiently large buffer in each cache agent for deadlock prevention.

### SUMMARY OF THE INVENTION

The present invention has been made to solve the conventional disadvantages. It is an object of the present invention to provide a data consistency control system and a data consistency control method that can dispense with including a sufficiently large buffer in a cache agent for deadlock prevention while making data consistency control simple.

According to one aspect of the present invention, there is provided a data consistency control system for controlling data consistency, comprising:

a plurality of cache agents;

at least one home agent; and

a plurality of networks,

wherein the cache agents and the home agent are connected to one another by the plurality of networks, and

the data consistency control system controls the data consistency between each of the cache agents and the home agent,

the plurality of networks includes at least
a network for communicating a snoop response; and
a network for communicating a snoop retry response,

the home agent includes a snoop request issuing unit issuing, when receiving an access request from one of the cache agents, a snoop request to each of the cache agents other than the cache agent that has transmitted the access request,

each of the cache agents includes
a snoop response issuing unit that controls the data consistency and issues the snoop response to the home agent when receiving the snoop request; and
a snoop retry response issuing unit that asks the home agent to retry issuing the snoop request and that issues the snoop retry response, and

the home agent includes
a management unit managing information as to which of the cache agents asks the home agent to retry issuing the snoop request when receiving the snoop retry response; and
a snoop request reissuing unit reissuing the snoop request to the cache agent that asks the home agent to retry issuing the snoop request based on the information managed by the management unit.

Further, the data consistency control system according to the aspect of the present invention may be configured so that each of the cache agents further includes a cache-side deadlock determining unit determining whether deadlock possibly occurs if receiving the snoop request and processing the snoop request, and so that if the cache-side deadlock determining unit determines that the deadlock possibly occurs, each of the cache agents issues the snoop retry response.

Moreover, the data consistency control system according to the aspect of the present invention may be configured so that the home agent further includes a snoop retry inhibiting unit, and so that if it is determined that the data consistency is disturbed or a congestion of the network occurs by causing the snoop request reissuing unit to reissue the snoop request, the snoop retry inhibiting unit inhibits the snoop request from being reissued.

The data consistency control system according to the aspect of the present invention may be configured so that the home agent further includes a home-side deadlock determining unit determining whether deadlock possibly occurs if the snoop request is reissued in response to the snoop retry response, if the home-side deadlock determining unit determines that the deadlock possibly occurs, the snoop retry response is recorded in the management unit, and so that if the home-side deadlock determining unit determines that the deadlock does not possibly occur, the snoop request is reissued without recording the snoop retry response in the management unit.

According to the present invention, it is possible to realize a data consistency control system and a data consistency control method that can dispense with including a sufficiently large buffer in a cache agent for deadlock prevention while making data consistency control simple.

### BRIEF DESCRIPTION OF THE DRAWINGS

FIG. 1 is a block diagram showing a configuration of a data consistency system according to a first embodiment of the present invention;

FIG. 2 shows an entry configuration of an access request management table according to the first embodiment;

FIG. 3 shows an entry configuration of a retry response management unit according to the first embodiment;

FIG. 4 is a flowchart showing an operation performed by a cache agent according to the first embodiment;

FIG. 5 is a flowchart showing a snoop retry response reception operation performed by the home agent according to the first embodiment;

FIG. 6 is a flowchart showing a snoop request reissue operation performed by the home agent according to the first embodiment;

FIG. 7 is a block diagram showing a configuration of a home controller according to a second embodiment of the present invention;

FIG. 8 shows an entry configuration of a retry response management unit according to the second embodiment;

FIG. 9 is a flowchart showing a snoop retry response reception operation performed by a home agent according to the second embodiment;

FIG. 10 is a flowchart showing a snoop request reissue operation performed by the home agent according to the second embodiment;

FIG. 11 shows an entry configuration of a retry response management unit according to a third embodiment of the present invention;

FIG. 12 is a block diagram showing a configuration of a conventional data consistency control system; and

FIG. 13 shows an entry configuration of an access request management table of the conventional data consistency control system.

### DESCRIPTION OF THE PREFERRED EMBODIMENTS

Embodiments of the present invention will be described hereinafter with reference to the accompanying drawings.

### First Embodiment

### (1) Data Consistency Control System According to the First Embodiment

### (1-1) Configuration of Data Consistency Control System

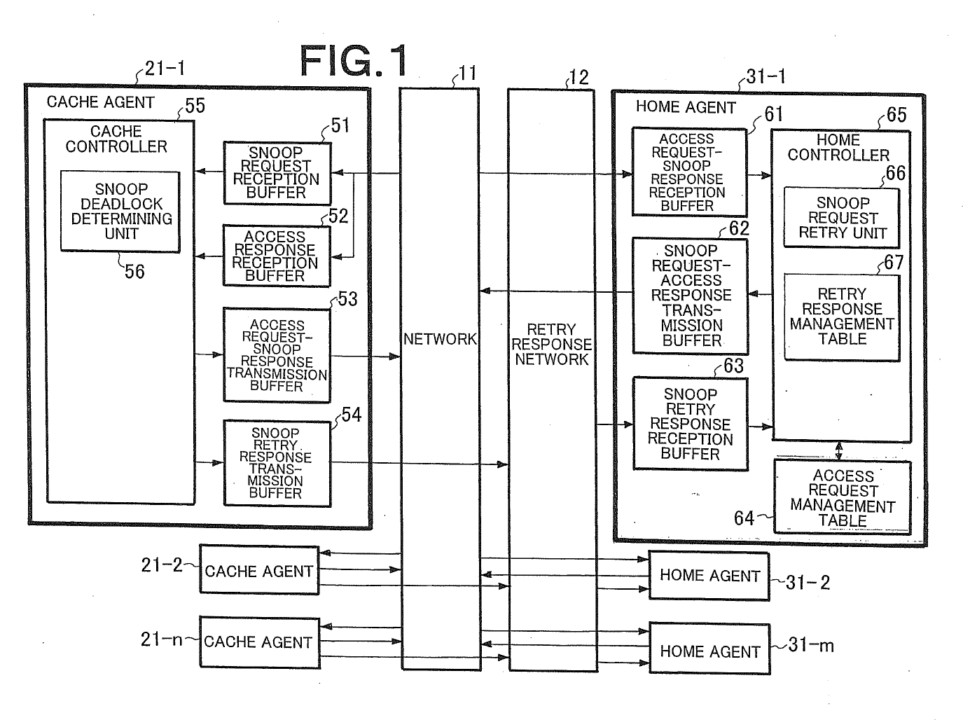

As shown in FIG. 1, a data consistency control system is configured so that a plurality of (n) cache agents 21 (21-1 to 21-n, where n is a natural number meaning a numeric value expressing the number of 1 to n) and a plurality of (m) home agents 31 (31-1 to 31-m, where m is a natural number meaning a numeric value expressing the number of 1 to m) are connected to one another by a network 11 and a retry response network 12.

A configuration of the cache agent 21-1 will be described by way of example. The cache agent 21-1 includes a cache controller 55 controlling data consistency as well as a snoop request reception buffer 51, an access response reception buffer 52, an access request-snoop response transmission buffer 53, and a snoop retry response transmission buffer 54 that are message transmission or reception buffers. The other cache agents 21-2 to 21-n are similar in configuration to the cache agent 21-1.

Among the buffers 51 to 54 included in the cache agent 21-1, only the snoop retry response transmission buffer 54 is connected to the retry response network 12 and the other buffers 51 to 53 are connected to the network 11.

The cache controller 55 includes a snoop deadlock determining unit 56 determining whether a deadlock possibly occurs if the cache agent 21 performs a processing in response to a snoop request message and issues a snoop response message.

Alternatively, the retry response network 12 can be realized as a virtual channel of the network 11.

A configuration of the home agent 31-1 will be described by way of example. The home agent 31-1 includes a home controller 65 controlling data consistency and an access request management table 64 recording an access request issued by each of the cache agents 21-1 to 21-n and managing a processing state as well as an access request-snoop response reception buffer 61, a snoop request-access response transmission buffer 62, and a snoop retry response reception buffer 63 that are message transmission or reception buffers. The other home agents 31-2 to 31-m are similar in configuration to the home agent 31-1.

Among the buffers 61 to 63 included in the home agent 31-1, only the snoop retry response reception buffer 63 is connected to the retry response network 12 and the other buffers 61 and 62 are connected to the network 11.

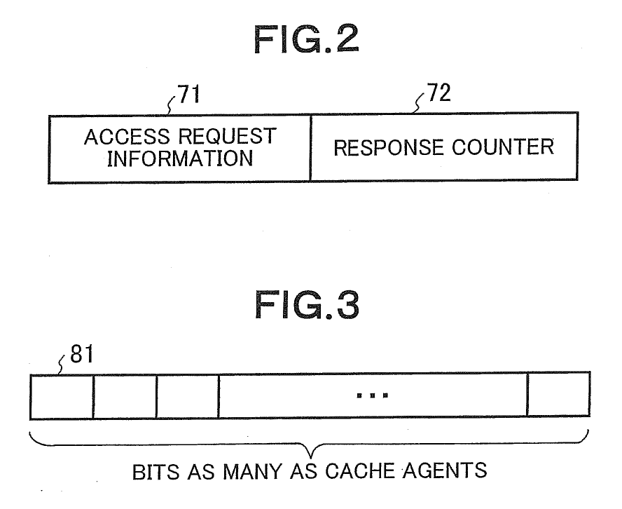

As shown in FIG. 2, access request information 71 and a response counter 72 are stored in respective entries of the access request management table 64.

The home controller 65 (FIG. 1) includes a retry response management table 67 and a snoop request retry unit 66.

Entries of the retry response management table 67 (FIG. 1) correspond to the entries of the access request management table 64 by one-to-one correspondence. As shown in FIG. 3, bit vectors that are bits 81 as many as the cache agents 21, for example, are stored in the respective entries of the retry response management table 67.

### (1-2) Operation Performed by Data Consistency Control System

The data consistency control system controls data consistency by communicating messages between the cache agents 21 and the home agents 31 via the network 11 and the retry response network 12. Characteristic operation of the first embodiment will be described.

If one cache agent 21 (e.g., 21-1) is to newly access data held in one home agent 31, the cache controller 55 generates an access request message addressed to the home agent 31 and outputs the generated access request message to the access request-snoop response transmission buffer 53.

The access request message stored in the access request-snoop response transmission buffer 53 is transmitted to the access request-snoop response reception buffer 61 of the home agent 31 via the network 11.

The home agent 31 receives the access request message from the access request-snoop response reception buffer 61, and sets access request information 71 (FIG. 2) in the entry of the access request management table 64.

Further, the home agent 31 generates a plurality of snoop request messages addressed to the cache agents 21 other than the cache agent 21-1, respectively, and outputs the snoop request messages to the snoop request-access response transmission buffer 62. At the same time, the number of issued snoop request messages is set to the response counter 72 (FIG. 2) in the entry of the access request management table 64.

A plurality of snoop request messages stored in the snoop request-access response transmission buffer 62 is transmitted to snoop request reception buffers 51 of the addressed cache agents 21 via the network 11, respectively.

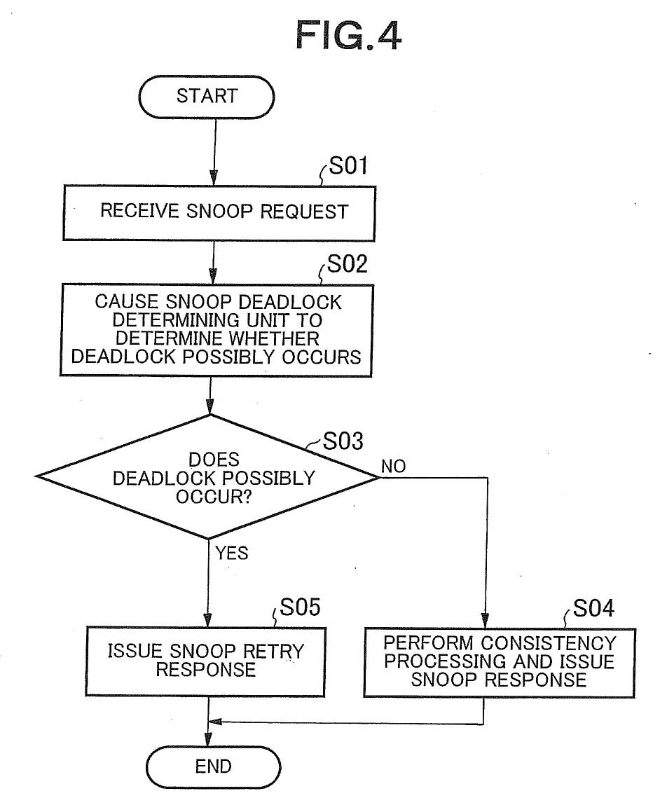

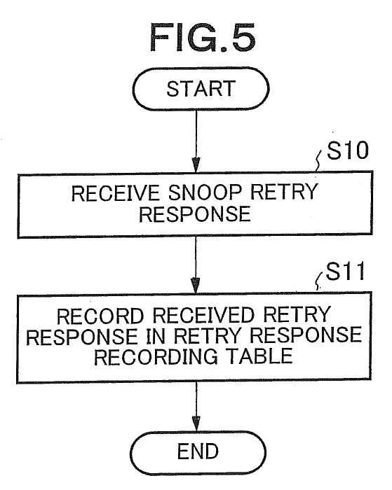

FIG. 4 is a flowchart showing operation performed by the cache controller 55 that receives one of the snoop request messages from the snoop request reception buffer 51.

Referring to the flowchart of FIG. 4, when the cache controller 55 first receives the snoop request message (step S01), the snoop deadlock determining unit 56 (FIG. 1) determines whether deadlock possibly occurs (step S02).

Specifically, the snoop deadlock determining unit 56 determines, for example, whether an empty space sufficient to be able to output a snoop response message to the access request-snoop response transmission buffer 53 is present in the access request-snoop response transmission buffer 53 (step S03). If no such empty space is present, the snoop deadlock determining unit 56 determines that deadlock possibly occurs (S03; Yes) and processing goes to a step S04. If such an empty space is present, the snoop deadlock determining unit 56 determines that deadlock does not possibly occur (S03; No) and the processing goes to a step S05.

At the step S04, the cache controller 55 performs a data consistency processing to generate a snoop response message, and outputs the snoop response message to the access request-snoop response transmission buffer 53.

At the step S05, the cache controller 55 generates a snoop retry response message without performing a data consistency processing, and outputs the snoop retry response message to the snoop retry response transmission buffer 54.

Further, at the step S04, the snoop response message stored in the access request-snoop response transmission buffer 53 is transmitted to the access request-snoop response reception buffer 61 of the home agent 31 via the network 11.

Further, at the step S05, the snoop retry response message stored in the snoop retry response transmission buffer 54 is transmitted to the snoop retry response reception buffer 63 of the home agent 31 via the retry response network 12.

The home agent 31 receives the snoop response message from the access request-snoop response reception buffer 61, and decrements a value of the response counter 72 (FIG. 2) by ‘1’ in the entry of the access request management table 64.

FIG. 5 is a flowchart showing operation performed by the home agent 31 that receives the snoop retry response message from the snoop retry response reception buffer 63.

Referring to FIG. 5, when the home agent 31 receives the snoop retry response message from the snoop retry response reception buffer 63 (step S10), the home agent 31 decrements the value of the response counter 72 (FIG. 2) in the entry of the access request management table 64 by ‘1’ and sets ‘1’ to the bit 81 (FIG. 3) in the corresponding entry of the retry response management table 67 (FIG. 1) (step S11).

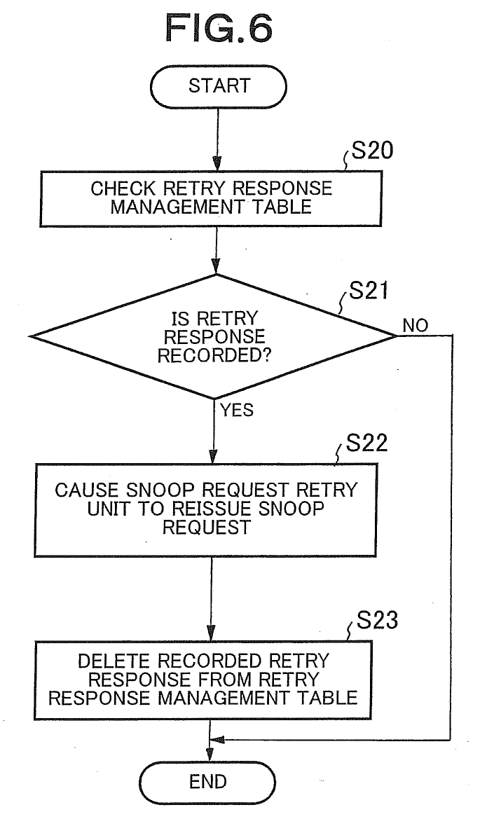

Next, operation performed by the snoop request retry unit 66 of the home agent 31 will be described with reference to the flowchart of FIG. 6.

Referring to FIG. 6, the snoop request retry unit 66 (FIG. 1) checks the retry response management table 67 (step S20) to search the entry in which the bit 81 is set to ‘1’ and a recorded position of the bit 81 (step S21).

If all the bits 81 are set to ‘0’ (step S21; No), processing is finished.

If the entry in which the bit 81 is set to ‘1’ is present (step S21; Yes), the processing goes to a step S22. At the step S22, the snoop request retry unit 66 selects the entry, reads the access request information 71 (FIG. 2) from the entry of the access request management table 64 (FIG. 1) corresponding to the selected entry of the retry response management table 67, generates a snoop request message addressed to the cache agent 21 corresponding to the bit 81 set to ‘1’, and outputs the snoop request message to the snoop request-access response transmission buffer 62 (step S22).

Furthermore, the snoop request retry unit 66 sets the bit 81 that has been set to ‘1’ in the entry of the retry response management table 67 to ‘0’ (step S23) and increments the response counter 72 (FIG. 2) in the access request management table 63 by ‘1’.

In this manner, the snoop request retry unit 66 of the home agent 31 operates.

The home controller 65 receives snoop response messages from a plurality of cache agents 21 other than the cache agent 21-1. If the home controller 65 receives all the snoop response messages corresponding to the issued snoop requests, i.e., if the home controller 65 receives the snoop response messages, the value of the response counter 72 (FIG. 2) as a result of the decrement is ‘0’, and all the bits 81 in the entries of the retry response management table 67 are set to ‘0’, then the home agent 31 generates an access response message addressed to the cache agent 21-1 that has issued the access request, and outputs the access response message to the snoop request-access response transmission buffer 62.

The access response message stored in the snoop request-access response transmission buffer 62 is transmitted to the access response reception buffer 52 of the addressed cache agent 21-1 via the network 11.

The cache agent 21-1 receives the access response message from the access response reception buffer 52, thus completing the data access processing.

### (1-3) Advantage of Data Consistency Control System

According to the first embodiment, the four types of messages, the access request message, the snoop request message, the snoop response message, and the access response message are all communicated via one network 11. Due to this, it is possible to secure an order of message arrival in a point-to-point architecture for those messages and, therefore, ensure simple data consistency control.

Furthermore, each cache agent 21 issues the snoop retry response to the snoop request and transmits the snoop retry response to the home agent 31 that has issued the snoop request via the network 12. Due to this, it is possible to prevent occurrence of deadlock even if the size of the snoop request reception buffer 51 of each of a plurality of cache agents 21 (21-1 to 21-n) is not set large sufficient to prevent overflow.

### Second Embodiment

### (2) Data Consistency Control System According to the Second Embodiment

### (2-1) Configuration of Data Consistency Control System

In the example shown in the first embodiment, the bit vectors that are the bits 81 as many as the cache agents 21 are stored in the respective entries of the retry response management table 67 as shown in FIG. 3.

Due to this, if the number n of cache agents 21 is larger, the size of the retry response management table 67 is larger accordingly.

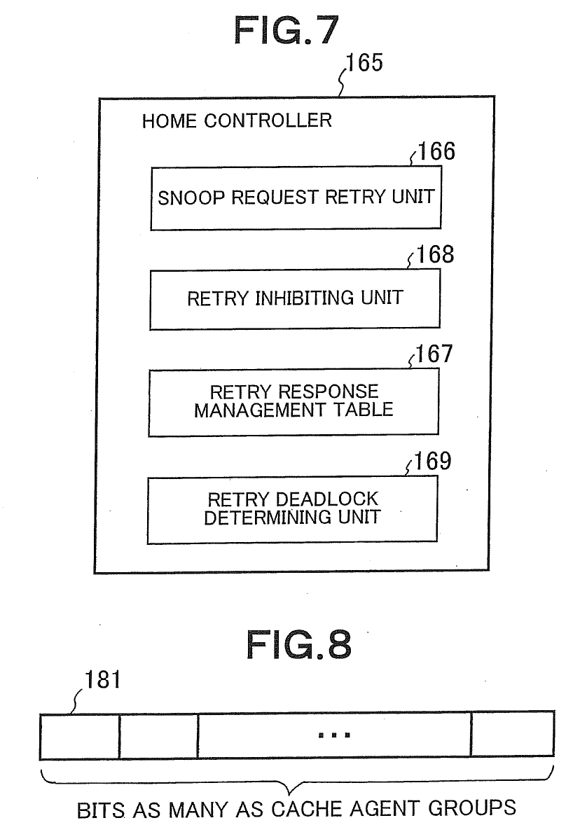

In a data consistency control system according to a second embodiment of the present invention, each home agent 31 includes a home controller 165 improved to prevent the retry response management table 67 from being made very large in size. FIG. 7 shows a configuration of the home controller 165 according to the second embodiment.

The home controller 165 shown in FIG. 7 includes a snoop request retry unit 166 and a retry response management table 167 similarly to the first embodiment, and further includes a retry inhibiting unit 168 and a retry deadlock determining unit 169.

The retry inhibiting unit 168 includes a part (not shown) inhibiting the snoop request retry unit 166 from generating a snoop request message.

The retry deadlock determining unit 169 (FIG. 7) determines whether deadlock possibly occurs if the home controller 165 receives a retry response message and reissues a snoop request message without recording a retry response in the retry response management table 167.

FIG. 8 shows an example of a configuration of entries of the retry response management table 167.

First, cache agent groups each including a plurality of cache agents 21 (some of the cache agents 21-1 to 21-n) are defined.

Specifically, if the data consistency control system includes 1024 cache agents 21, for example, eight cache agent groups each including 128 cache agents 21 are created.

As shown in FIG. 8, bit vectors that are bits 181 as many as the cache agent groups are stored in respective entries of the retry response management table 167 (FIG.7). If a certain bit 181 is set to ‘1’, this indicates that the home agent 31 receives a snoop retry response from at least one cache agent 21 belonging to the corresponding cache agent group.

The data consistency control system according to the second embodiment is configured as described above and operates as follows.

### (2-2) Operation Performed by Data Consistency Control System

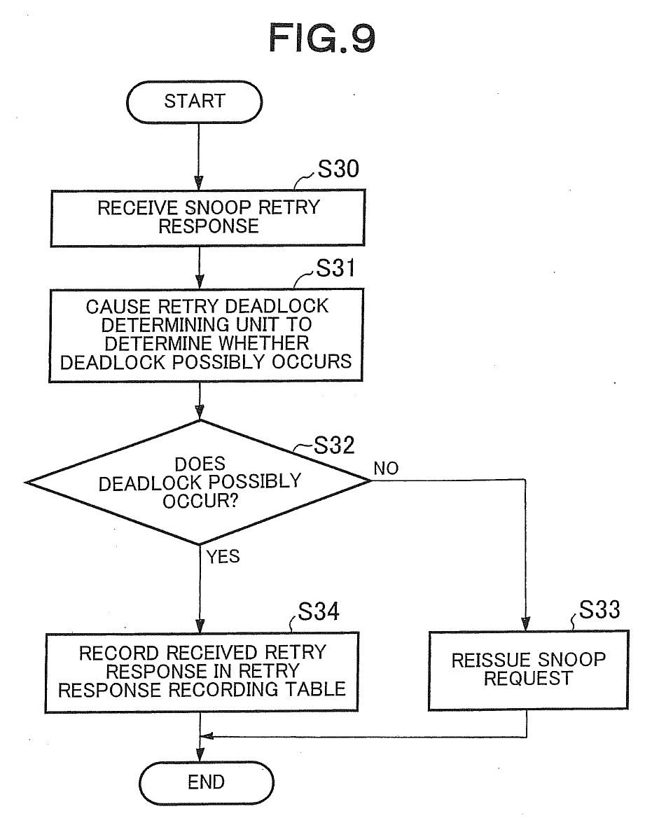

FIG. 9 is a flowchart showing operation if the home controller 165 receives a snoop retry response.

Referring to the flowchart of FIG. 9, when the home controller 165 first receives a snoop retry response (step S30), the retry deadlock determining unit 169 (FIG. 7) determines whether deadlock possibly occurs (step S31).

Specifically, the retry deadlock determining unit 169 determines, for example, whether an empty space sufficient to be able to output a snoop request message to the snoop request-access response transmission buffer 62 (FIG. 1) is present in the snoop request-access response transmission buffer 62 (step S32).

If no such empty space is present, the retry deadlock determining unit 169 determines that deadlock possibly occurs (S32; Yes) and processing goes to a step S34. If such an empty space is present, the retry deadlock determining unit 169 determines that deadlock does not possibly occur (S32; No) and the processing goes to a step S33.

At the step S34, the home controller 165 decrements a value of the response counter 72 (FIG. 2) in the entry of the access request management table 64 by ‘1’ and sets ‘1’ to the bit 181 in the corresponding entry of the retry response management table 167 (FIG. 7).

At the step S33, the home controller 165 reads the access request information 71 from the corresponding entry of the access request management table 64 (FIG. 1), generates a snoop request message addressed to the cache agent 21 that has issued the snoop retry response message, and outputs the snoop request message to the snoop request-access response transmission buffer 62.

By doing so, it is possible to decrease the number of accesses to the access request management table 64 as compared with an instance of recording a retry response message in the retry response management table 167 (FIG. 7) and causing the snoop request retry unit 166 to generate snoop request messages. It is, therefore, possible to improve performance of the data consistency control system.

Moreover, the snoop request retry unit 166 (FIG. 7) generates snoop request messages to a plurality of cache agents 21 belonging to the corresponding cache agent group as will be described later. At the step S33, the number of snoop request messages generated is limited to one. Therefore, it is advantageously possible to suppress the number of generated snoop request messages.

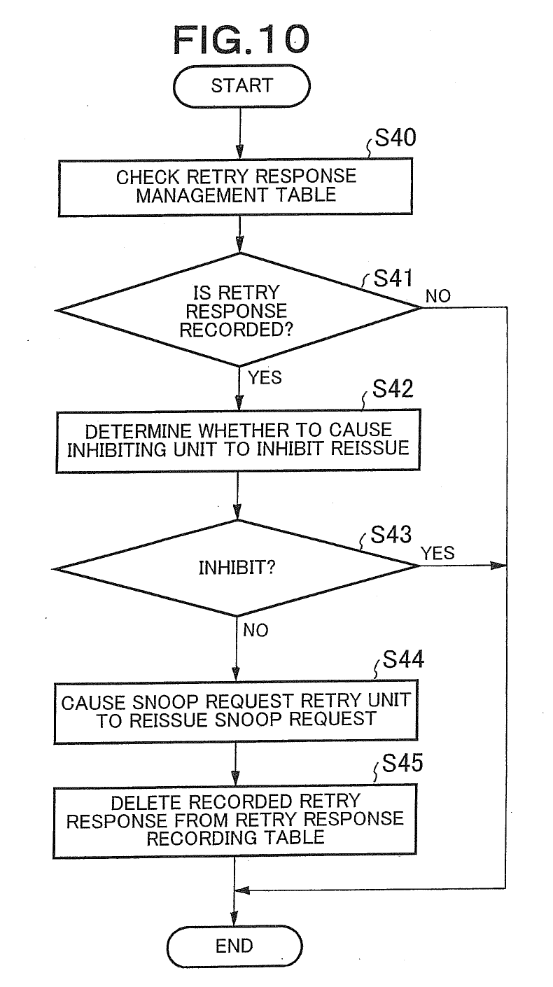

Operation performed by the snoop request retry unit 166 (FIG. 7) will next be described with reference to the flowchart of FIG. 10.

Referring to the flowchart of FIG. 10, the snoop request retry unit 166 (FIG. 7) checks the retry response management table 167 (FIG. 7) (step S40) to search an entry in which the bit 181 is set to ‘1’ and a recorded position of the bit 181 (step S41).

If all the bits 181 are set to ‘0’ (step S41; No), processing is finished.

If the entry in which the bit 181 is set to ‘1’ is present (step S41; Yes), the processing goes to a step S42. At the step S42, the snoop request retry unit 166 selects the entry, and determines whether to cause the retry inhibiting unit 168 (FIG. 7) to inhibit a snoop request from being reissued (step S42).

Specifically, the snoop request retry unit 166 checks, for example, whether the value of the response counter 72 in the corresponding entry of the access request management table 64 (FIG. 1) is ‘0’ and, if the value is not ‘0’, causes the retry inhibiting unit 168 to inhibit snoop request messages from being reissued (step S43; Yes).

Alternatively, the snoop request retry unit 166 can check whether the value of the response counter 72 (FIG. 2) overflows if the snoop request is reissued to the cache agent group and the number of reissued snoop request messages is added to the response counter 72. If the value overflows, the snoop request retry unit 166 causes the retry inhibiting unit 168 to inhibit snoop request messages from being reissued (step S44).

On the other hand, if the reissue is not inhibited (step S43; No), the snoop request retry unit 166 (FIG. 7) reissues snoop request messages (step S44).

In this example, the snoop request retry unit 166 reads the access request information 71 (FIG. 2) from the entry of the access request management table 64 (FIG. 1) corresponding to the selected entry of the retry response management table 167, generates snoop request messages addressed to a plurality of the cache agents 21, respectively belonging to the cache agent group corresponding to the bit 181 set to ‘1’, and outputs the snoop request messages to the snoop request-access response transmission buffer 62.

At the same time, the snoop request retry unit 166 sets the bit 181 that has been set to ‘1’ in the entry of the retry response management table 167 to ‘0’ and increments the response counter 72 (FIG. 2) in the access request management table 63 by the number of reissued snoop request messages (step S45).

It is thereby possible to suppress the retry response management table 167 from being made very large in size and prevent operation error resulting from the overflow of the response counter 72.

Moreover, by configuring the data consistency control system as described above and causing the system to operate as described above, it is possible to secure an order of message arrival in a point-to-point architecture for the four types of messages, i.e., the access request message, the snoop request message, the snoop response message, and the access response message and, therefore, ensure simple data consistency control similarly to the first embodiment.

Furthermore, it is possible to prevent occurrence of deadlock even if the size of the snoop request reception buffer 51 of each cache agent 21 is not set large for preventing overflow of the buffer 51.

### Third Embodiment

### (3) Data Consistency Control System According to the Third Embodiment

The retry inhibiting unit 168 according to the second embodiment may possibly have the following disadvantages. The retry inhibiting unit 168 inhibits a snoop request message from being reissued until all the snoop response messages or snoop retry response messages are eliminated. Alternatively, if a plurality of snoop retry response messages is transmitted from a plurality of cache agents 21 belonging to a certain cache agent group, it is necessary that the retry inhibiting unit 168 reissues snoop request messages to the cache agents 21 in the cache agent group a number of times. As a result, congestion of the network 11 may possibly occur and the performance of the data consistency control system may be possibly deteriorated.

According to a third embodiment of the present invention, a method for solving these disadvantages is shown.

### (3-1) Configuration of Data Consistency Control System

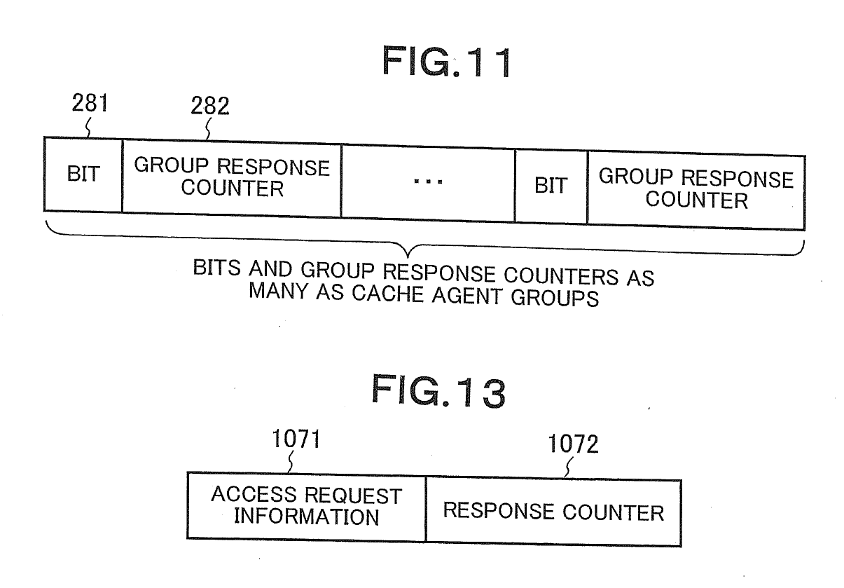

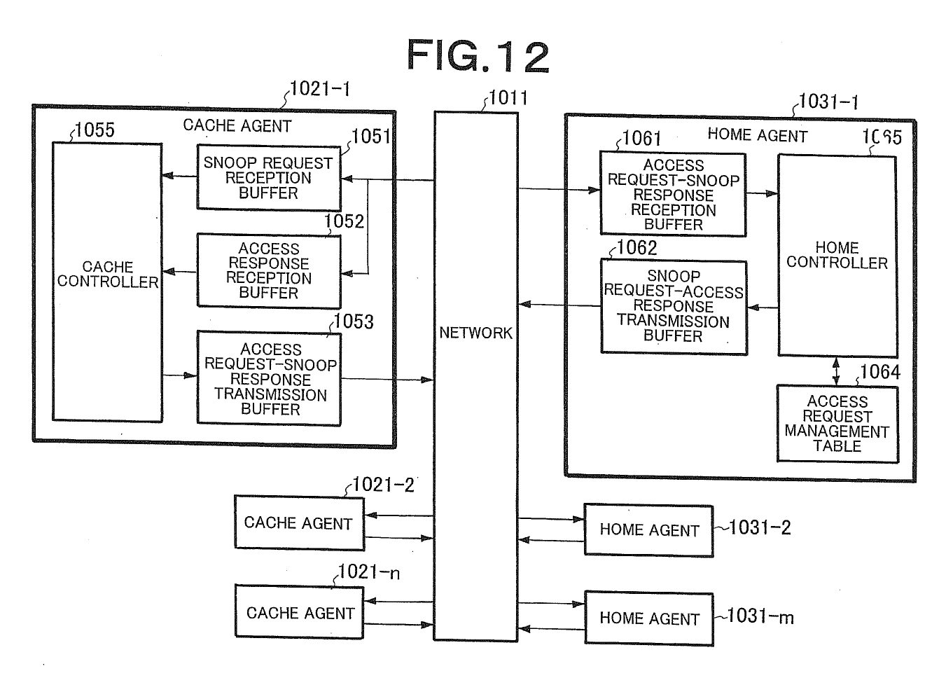

As a modification of the second embodiment, the retry response management table 167 is configured as shown in FIG. 11. In FIG. 11, the retry response management table 167 is configured to include bits 281 and group response counters 282 as many as cache agent groups.

If the home controller 165 (FIG. 7) is to transmit a snoop request message, how many snoop request messages are issued to a plurality of cache agents 21 belonging to each of the cache agent groups is recorded in each of the group response counters 282 (FIG. 11) in the corresponding entry.

If the home controller 165 (FIG. 7) receives a snoop response message from one cache agent 21 belonging to a certain cache agent group, the value of the corresponding group response counter 282 (FIG. 11) is decremented by ‘1’.

Further, if the home controller 165 (FIG. 7) receives a snoop retry response message from one cache agent 21 belonging to a certain cache agent group and records the snoop retry response message in the retry response management table 167 (FIG. 7), the value of the corresponding group response counter 282 (FIG. 11) is also decremented by ‘1’.

The retry inhibiting unit 168 (FIG. 7) inhibits a retry response message from being reissued if the value of the corresponding group response counter 282 (FIG. 11) is not ‘0’.

By so configuring, as long as all the snoop response messages or snoop retry response messages in one cache agent group can be eliminated, it is possible to reissue a snoop request message to the cache agents 21 belonging to the certain cache agent group. Due to this, it is unnecessary to wait until all the snoop response messages or snoop retry response messages are eliminated.

Furthermore, even if a plurality of snoop retry response messages is transmitted from a plurality of cache agents 21 belonging to a certain cache agent group, there is no need to reissue snoop request messages to the cache agents 21 a number of times. It is thereby possible to prevent congestion of the network 11.

Moreover, by configuring the data consistency control system as described above and causing the system to operate as described above, it is possible to secure an order of message arrival in a point-to-point architecture for the four types of messages, i.e., the access request message, the snoop request message, the snoop response message, and the access response message and, therefore, ensure simple data consistency control similarly to the first embodiment.

Furthermore, it is possible to prevent occurrence of deadlock even if the size of the snoop request reception buffer 51 of each cache agent 21 is not set large for preventing overflow of the buffer 51.

The present invention is applicable to a system necessary to control data consistency.

Although the exemplary embodiments of the present invention have been described in detail, it should be understood that various changes, substitutions and alternatives can be made therein without departing from the sprit and scope of the invention as defined by the appended claims. Further, it is the inventor's intent to retain all equivalents of the claimed invention even if the claims are amended during prosecution.

What is claimed is:

1. A data consistency control system for controlling data consistency, comprising:
a plurality of cache agents;
at least one home agent; and
a plurality of networks,
wherein the cache agents and the home agent are connected to one another by the plurality of networks, and
the data consistency control system controls the data consistency between each of the cache agents and the home agent,
the plurality of networks includes at least
a network for communicating a snoop response; and
a network for communicating a snoop retry response,
the home agent includes a snoop request issuing unit issuing, when receiving an access request from one of the cache agents, a snoop request to each of the cache agents other than the cache agent that has transmitted the access request,
each of the cache agents includes
a snoop response issuing unit that controls the data consistency and issues the snoop response to the home agent when receiving the snoop request; and
a snoop retry response issuing unit that asks the home agent to retry issuing the snoop request and that issues the snoop retry response, and
the home agent includes
a management unit managing information as to which of the cache agents asks the home agent to retry issuing the snoop request when receiving the snoop retry response; and
a snoop request reissuing unit reissuing the snoop request to the cache agent that asks the home agent to retry issuing the snoop request based on the information managed by the management unit.

2. The data consistency control system according to claim 1,
wherein each of the cache agents further includes a cache-side deadlock determining unit determining whether deadlock possibly occurs if receiving the snoop request and processing the snoop request, and
if the cache-side deadlock determining unit determines that the deadlock possibly occurs, each of the cache agents issues the snoop retry response.

3. The data consistency control system according to claim 1,
wherein the home agent further includes a snoop retry inhibiting unit, and
if it is determined that the data consistency is disturbed or a congestion of the network occurs by causing the snoop request reissuing unit to reissue the snoop request, the snoop retry inhibiting unit inhibits the snoop request from being reissued.

4. The data consistency control system according to claim 1,
wherein the home agent further includes a home-side deadlock determining unit determining whether deadlock possibly occurs if the snoop request is reissued in response to the snoop retry response,
if the home-side deadlock determining unit determines that the deadlock possibly occurs, the snoop retry response is recorded in the management unit, and
if the home-side deadlock determining unit determines that the deadlock does not possibly occur, the snoop request is reissued without recording the snoop retry response in the management unit.

5. A data consistency control method for a data consistency control system for controlling data consistency, data consistency control system comprising:
a plurality of cache agents;
at least one home agent; and
a plurality of networks,
wherein the cache agents and the home agent are connected to one another by the plurality of networks, and
the data consistency control system controls the data consistency between each of the cache agents and the home agent,
the plurality of networks includes at least
a network for communicating a snoop response; and
a network for communicating a snoop retry response,
the data consistency control method comprising:
a snoop request issuing step of causing the home agent to issue, when the home agent receives an access request from one of the cache agents, a snoop request to each of the cache agents other than the cache agent that has transmitted the access request;
a snoop response issuing step of causing each of the cache agents to control the data consistency and to issue the snoop response to the home agent when each of the cache agents receives the snoop request;
a snoop retry response issuing step of causing each of the cache agents to ask the home agent to retry issuing the snoop request and to issue the snoop retry response;
a management step of causing the home agent to manage information as to which of the cache agents asks the home agent to retry issuing the snoop request when the home agent receives the snoop retry response; and
a snoop request reissuing step of causing the home agent to reissue the snoop request to the cache agent that asks the home agent to retry issuing the snoop request based on the information managed at the management step.

6. The data consistency control method according to claim 5, further comprising:
a cache-side deadlock determining step of causing each of the cache agents to determine whether deadlock possibly occurs if each of the cache agents receives the snoop request and processes the snoop request,
wherein, if it is determined at the cache-side deadlock determining step that the deadlock possibly occurs, each of the cache agents issues the snoop retry response.

7. The data consistency control method according to claim 5, further comprising:
a snoop retry inhibiting step of causing the home agent to inhibit a snoop retry,
wherein, if it is determined that the data consistency is disturbed or a congestion of the network occurs by reissuing the snoop request at the snoop request reissuing step, the snoop request is inhibited from being reissued at the snoop retry inhibiting step.

8. The data consistency control method according to claim 5, further comprising:
a home-side deadlock determining step of causing the home agent to determine whether deadlock possibly occurs if the snoop request is reissued in response to the snoop retry response,
wherein, if it is determined at the home-side deadlock determining step that the deadlock possibly occurs, the snoop retry response is recorded at the management step, and
if it is determined at the home-side deadlock determining step that the deadlock does not possibly occur, the snoop request is reissued without recording the snoop retry response at the management step.
